(19) United States
(12) Patent Application Publication
(10) Pub. No.: US 2024/0229184 A1
(43) Pub. Date: Jul. 11, 2024

(54) COILING TEMPERATURE INFLUENCED COLD ROLLED STRIP OR STEEL

(71) Applicant: VOESTALPINE STAHL GMBH, Linz (AT)

(72) Inventors: Michael SCHWARZENBRUNNER, Walding (AT); Katharina STEINEDER, Linz (AT); Martin GRUBER, Pregarten (AT); Thomas MORTLBAUER, Linz (AT)

(21) Appl. No.: 18/269,279

(22) PCT Filed: Dec. 23, 2021
(86) PCT No.: PCT/EP2021/087599

§ 371 Date: Jun. 22, 2023

(30) Foreign Application Priority Data
Dec. 23, 2020 (SE) 2051558-1

(51) Int. Cl. C21D 9/52; C21D 6/00; C21D 8/02; C22C 38/02; C22C 38/06; C22C 38/38

(52) U.S. Cl. CPC C21D 9/52; C21D 6/002; C21D 6/005; C21D 6/008; C21D 8/0205; C21D 8/0226; C21D 8/0236; C21D 8/0263; C22C 38/02; C22C 38/06; C22C 38/38; C21D 2211/001; C21D 2211/002; C21D 2211/005; C21D 2211/008

(57) ABSTRACT

A cold roll strip or sheet includes in (wt %): C 0.12-0.20; Mn 1.9-2.6; Cr 0.15-0.3; Si 0.3-0.8; Al 0.8-1.2; Mn+Cr 1.8-5; Nb≤0.008; Ti≤0.02; Mo≤0.08; Ca≤0.005; V≤0.02; and balance Fe apart from impurities. The steel is within the area defined by the coordinates A, B, C, D, where Ri/t (y-axle) is plotted vs TS (MPa)/YR (x-axle), and where A is [2200, 3.5], B is [2600, 4.5], C is [2600, 3], and D is [2200, 2].

### CROSS-REFERENCE TO RELATED APPLICATION(S)

This is a National Stage Entry into the United States Patent and Trademark Office from International Patent Application No. PCT/EP2021/087599, filed on Dec. 23, 2021, which relies on and claims priority to Swedish Patent Application No. 2051558-1, filed on Dec. 23, 2020, the entire contents of both of which are incorporated herein by reference.

### FIELD OF THE INVENTION

The present invention relates to high strength steel strips and sheets suitable for applications in automobiles.

### BACKGROUND OF THE INVENTION

For a great variety of applications increased strength levels are a pre-requisite for light-weight constructions in particular in the automotive industry, since car body mass reduction results in reduced fuel consumption.

Automotive body parts are often stamped out of sheet steels, forming complex structural members of thin sheet. However, such parts cannot be produced from conventional high strength steels, because of a too low formability of the complex structural parts. For this reason, multi-phase Transformation Induced Plasticity aided steels (TRIP steels) have gained considerable interest in the last years, in particular for use in auto body structural parts and as seat frame materials.

TRIP steels possess a multi-phase microstructure, which includes a meta-stable retained austenite phase, which is capable of producing the TRIP effect. When the steel is deformed, the austenite transforms into martensite, which results in remarkable work hardening. This hardening effect acts to resist necking in the material and postpones failure in sheet forming operations. The microstructure of a TRIP steel can greatly alter its mechanical properties.

TRIP steels have been known for long and attracted a lot of interest, mainly because the bainitic ferrite matrix allows an excellent stretch flangeability. Moreover, the TRIP effect ensured by the strain-induced transformation of metastable retained austenite islands into martensite, remarkably improves their drawability.

When producing cold rolled TRIP steel sheets a slab is initially provided. The slab is hot rolled in austenitic temperature range to a hot rolled strip. The hot rolled strip is thereafter coiled. The coiling resistance is reduced with increasing temperature. Commonly a coiling temperature of 600° C. is employed. The coiled strip is thereafter batch annealed, followed by cold rolling. The cold rolled strip is thereafter continuously annealed.

WO 2019/122963 A1 and WO2019123043 A1 both discloses a TRIP steel with improved phosphonation coverage. A good phosphonation coverage is enabled. The improved phosphonation coverage was achieved by controlling the alloying elements and the process parameters of which one is to have a low coiling temperature. All inventive examples have a coiling temperature of 450° C. Reference examples with higher coiling temperatures did not provide sufficient phosphonation coverage. A low coiling temperature increases cold rolling forces.

EP 2707514 B1 disclose a TRIP steel having a microstructure comprising of 5-20% polygonal ferrite, 10-15% residual austenite, 5-15% martensite and balance bainite. According to the document the presence of polygonal ferrite between 5 and 20% makes it possible to exceed a V-bending angle of 90° without the occurrence of cracking.

WO2018116155 disclose a TRIP steel. The inventive examples disclose a lower coiling temperature of 450° C. in combination with a higher batch annealing temperature of 620° C. respectively 650° C., and a higher coiling temperature of 560° C. in combination with a lower batch annealing temperature of 460° C.

Example 58 of U.S. Pat. No. 10,113,223 B2 disclose a YS of 822 MPa, a TS of 1062 MPa, and yield ratio of Example 58 of U.S. Pat. No. 10,113,223 B2 disclose a YS of 822 MPa, a TS of 1062 MPa, and yield ratio of ≤8%, preferably ≤5%, more preferably 0-3%. In all examples residual austenite is 4% or lower.

Although these steels disclose several attractive properties there is demand for >950 MPa steel sheet or strip having an improved property profile with respect to advanced forming operations, in particular bending properties. In particular bending property in relation to strength and toughness. Further desirable properties are: reduced grain-boundary oxidation, reduced susceptibility to Liquid metal embrittlement, reduced susceptibility to hydrogen embrittlement, and a good phosphatability.

### SUMMARY OF THE INVENTION

The present invention is directed to cold rolled steels having a tensile strength of at least 950 MPa and an excellent formability, wherein it should be possible to produce the steel sheets/strips on an industrial scale in a Continuous Annealing Line (CAL) and in a Hot Dip Galvanizing Line (HDGL). The invention aims at providing a steel having a composition and microstructure that can be processed to complicated high strength structural members, where the bending properties are of importance.

The careful selection of alloying elements and process parameters reduces grain boundary oxidation. The reduced grain boundary oxidation improves bendability and reduces the risk of liquid metal embrittlement and susceptibility to hydrogen embrittlement. It further facilitates good phosphatability.

### BRIEF DESCRIPTION OF THE DRAWINGS

FIG. 1 shows a graph with the inventive samples within a within the dotted lines.

### DETAILED DESCRIPTION OF EMBODIMENT(S) OF THE INVENTION

The invention is described in the paragraphs that follow.

The steel sheet has a composition consisting of the following alloying elements (in wt. %):

| | |
|---|---|
| C | 0.08-0.28 |
| Mn | 1.5-4.5 |
| Cr | 0.01-0.5 |
| Si | 0.01-2.5 |
| Al | 0.5-2.0 |
| Mn + Cr | 1.8-5 |
| Nb | ≤0.1 |
| Ti | ≤0.1 |
| Mo | ≤0.5 |
| Ca | ≤0.05 |
| V | ≤0.1 |

balance Fe apart from impurities.

The importance of the separate elements and their interaction with each other as well as the limitations of the chemical ingredients of the claimed alloy are briefly explained in the following. All percentages for the chemical composition of the steel are given in weight % (wt. %) throughout the description. Upper and lower limits of the individual elements can be freely combined within the limits set out in the claims. The arithmetic precision of the numerical values can be increased by one or two digits for all values given in the present application. Hence, a value of given as e.g. 0.1% can also be expressed as 0.10 or 0.100%. The amounts of the microstructural constituents are given in volume % (vol. %).

### C: 0.08-0.28%

C stabilizes the austenite and is important for obtaining sufficient carbon within the retained austenite phase. C is also important for obtaining the desired strength level. Generally, an increase of the tensile strength in the order of 100 MPa per 0.1% C can be expected. When C is lower than 0.08% it is difficult to attain a tensile strength of 950 MPa. If C exceeds 0.28%, then the weldability is impaired. The upper limit may thus be 0.26, 0.24 or 0.22%, 0.20 or 0.18%. The lower limit may be 0.10, 0.12, 0.14, or 0.16%.

### Mn: 1.5-4.5%

Manganese is a solid solution strengthening element, which stabilises the austenite by lowering the Mₛ temperature and prevents ferrite and pearlite to be formed during cooling. In addition, Mn lowers the A_{c3} temperature and is important for the austenite stability. At a content of less than 1.5% it might be difficult to obtain the desired amount of retained austenite, a tensile strength of 950 MPa and the austenitizing temperature might be too high for conventional industrial annealing lines. However, if the amount of Mn is higher than 4.5%, problems with segregation may occur because Mn accumulates in the liquid phase and causes banding, resulting in a potentially deteriorated workability. The upper limit may therefore be 4.2, 4.0, 3.8, 3.6, 3.4, 3.2, 3.0, 2.8, 2.6, or 2.4%. The lower limit may be 1.5, 1.7, 1.9, 2.1, 2.3, or 2.5%.

### Cr: 0.01-0.5%

Cr is effective in increasing the strength of the steel sheet. Cr is an element that forms ferrite and retards the formation of pearlite and bainite. The A_{c3} temperature and the Mₛ temperature are only slightly lowered with increasing Cr content. Cr results in an increased amount of stabilized retained austenite. When above 0.5% it may impair surface finish of the steel, and therefore the amount of Cr is limited to 0.5%. The upper limit may be 0.45 or 0.40, 0.35, 0.30 or 0.25%. The lower limit may be 0.01, 0.03, 0.05, 0.07, 0.10, 0.15, 0.20 or 0.25%. Preferably, a deliberate addition of Cr is not conducted according to the present invention.

### Si: 0.01-2.5%

Si acts as a solid solution strengthening element and is important for securing the strength of the thin steel strip. Si suppresses the cementite precipitation and is essential for austenite stabilization. However, if the content is too high, then too much silicon oxides will form on the strip surface, which may lead to cladding on the rolls in the CAL and, as a result there of, to surface defects on subsequently produced steel sheets. The upper limit is therefore 2.5% and may be restricted to 2.4, 2.2, 2.0, 1.8, 1.6, 1.4, 1.2, 1.0, or 0.8%. The lower limit may be 0.01, 0.05, 0.1, 0.2, 0.4, 0.60, 0.80 or 1.0%.

### Al: 0.5-2.0%

Al promotes ferrite formation and is also commonly used as a deoxidizer. Al, like Si, is not soluble in the cementite and therefore it considerably delays the cementite formation during bainite formation. In addition, galvanization and reduced susceptibility to Liquid metal embrittlement can be improved. Additions of Al result in a remarkable increase in the carbon content in the retained austenite. A main disadvantage of Al is its segregation behaviour during casting. During casting Mn is enriched in the middle of the slabs and the Al-content is decreased. Therefore, in the middle of the slab a significant austenite stabilized region or band may be formed. This results at the end of the processing in martensite banding and that low strain internal cracks are formed in the martensite band. On the other hand, Si and Cr are also enriched during casting. Hence, the propensity for martensite banding may be reduced by alloying with Si and Cr, since the austenite stabilization due to the Mn enrichment is counteracted by these elements. For these reasons the Al content is preferably limited. The upper level may be 2.0, 1.8, 1.7, 1.6, 1.5, 1.4, 1.3, 1.2 or 1.1%. The lower limit may be set to 0.5, 0.6, 0.7, 0.8, or 0.9%.

$$Si + Al \geq 0.5 \%$$

Si and Al suppress the cementite precipitation during bainite formation. Their combined content is therefore preferably at least 0.5%. The lower limit may be 0.7, 0.8, 0.9, 1.0. 1.1, 1.2, or 1.3%.

$$Mn + Cr 1.8 - 5$$

Manganese and Chromium affects the hardenability of the steel. Their combined content is preferably within the range of 1.8-5.0%.

### Optional Elements

### Mo≤0.5%

Molybdenum is a powerful hardenability agent. It may further enhance the benefits of NbC precipitates by reducing the carbide coarsening kinetics. The steel may therefore contain Mo in an amount up to 0.5%. The upper limit may be restricted to 0.4, 0.3, 0.2, or 0.1%. However, a deliberate addition of Mo is not necessary according to the present invention. The upper limit may therefore be restricted to ≤0.01%.

### Nb:≤0.1%

Nb is commonly used in low alloyed steels for improving strength and toughness, because of its influence on the grain size. Nb increases the strength elongation balance by refining the matrix microstructure and the retained austenite phase due to precipitation of NbC. The steel may contain Nb in an amount of ≤0.1%. The upper limit may be restricted to 0.09, 0.07, 0.05, 0.03, or 0.01%. A deliberate addition of Nb is not necessary according to the present invention. The upper limit may therefore be restricted to ≤0.004%.

### V:≤0.1%

The function of V is similar to that of Nb in that it contributes to precipitation hardening and grain refinement. The steel may contain V in an amount of ≤0.1%. The upper limit may be restricted to 0.09, 0.07, 0.05, 0.03, or 0.01%. A deliberate addition of V is not necessary according to the present invention. The upper limit may therefore be restricted to ≤0.01%.

### Ti:≤0.1%

Ti is commonly used in low alloyed steels for improving strength and toughness, because of its influence on the grain size by forming carbides, nitrides or carbonitrides. In particular, Ti is a strong nitride former and can be used to bind the nitrogen in the steel. However, the effect tends to be saturated above 0.1%. The upper limit may be restricted to 0.09, 0.07, 0.05, 0.03, or 0.01%. A deliberate addition of Ti is not necessary according to the present invention. The upper limit may therefore be restricted to ≤0.005%.

### Ca≤0.05%

Ca may be used for the modification of the non-metallic inclusions. The upper limit is 0.05% and may be set to 0.04, 0.03, 0.01%. A deliberate addition of Ca is not necessary according to the present invention. The upper limit may therefore be restricted to ≤0.005%.

### Impurities

### Cu:≤0.06%

Cu is an undesired impurity element that is restricted to ≤0.06% by careful selection of the scrap used.

### Ni:≤0.08%

Ni is also an undesired impurity element that is restricted to ≤0.08% by careful selection of the scrap used.

### B:≤0.0006%

B is an undesired impurity element that is restricted to ≤0.0006% by careful selection of the scrap used. B increases hardness but may come at a cost of reduced bendability and is therefore not desirable in the present suggested steel. B may further make scrap recycling more difficult and an addition of B may also deteriorate workability. A deliberate addition of B is therefore not desired according to the present invention.

Other impurity elements may be comprised in the steel in normal occurring amounts. However, it is preferred to limit the amounts of P, S, As, Zr, Sn to the following optional maximum contents:
P:≤0.02%
S:≤0.005%
As≤0.010%
Zr≤0.006%
Sn≤0.015%

It is also preferred to control the nitrogen content to the range:
N:≤0.015%, preferably 0.003-0.008%
   In this range a stable fixation of the nitrogen can be achieved.

Oxygen and hydrogen can further be limited to
O:≤0.0003
H:≤0.0020

The microstructural constituents are in the following expressed in volume % (vol. %).

The cold rolled steel sheets of the present invention have a microstructure comprising at least 40% tempered martensite (TM) and bainite (B).

And further, 10-30% fresh martensite (FM). The upper limit may be restricted 28, 26, 24 or 22%. The lower limit may be restricted 12, 14, 16 or 18%. The fresh martensite may improve edge flangeability and local ductility. These un-tempered martensite particles are often in close contact with the retained austenite particles and they are therefore often referred to as martensite-austenite (MA) particles.

Retained austenite is a prerequisite for obtaining the desired TRIP effect. The amount of retained austenite should therefore be in the range of 2-20%, preferably 5-15%. The amount of retained austenite was measured by means of the saturation magnetization method described in detail in Proc. Int. Conf. on TRIP-aided high strength ferrous alloys (2002), Ghent, Belgium, p. 61-64.

And further 10-35% polygonal ferrite (PF). Upper limit may be 30 or 25%. Lower limit may be 15 or 20%.

The mechanical properties of the claimed steel are important, and the following requirements should be fulfilled:

| | | |
|---|---|---|
| TS tensile strength (Rₘ) | 950-1350 | MPa |
| YS yield strength (Rp_{0.2}) | 350-1150 | MPa |
| bendability (Ri/t) | ≤4 | |
| YR yield ratio (Rp_{0.2}/Rₘ) | | ≥0.35 |

The Rₘ, R_{p0.2} values are derived according to the European norm EN 10002 Part 1, wherein the samples are taken in the longitudinal direction of the strip. The total elongation (A₅₀) is derived in accordance with the Japanese Industrial Standard JIS Z 2241: 2011, wherein the samples are taken in the transversal direction of the strip.

The lower limit for the yield strength can be 350, 360, 370, 380, 390, or 400 MPa.

The bendability is evaluated by the ratio of the limiting bending radius (Ri), which is defined as the minimum bending radius with no occurrence of cracks, and the sheet thickness, (t). For this purpose, a 90° V-shaped block is used to bend the steel sheet in accordance with JIS Z2248. The value obtained by dividing the limit bending radius with the thickness (Ri/t) should be less than 4, preferably less than 3.5.

The upper limit for Ri/t may be 4.0, 3.9, 3.8, 3.7, 3.6, or 3.5. The lower limit may be 2.0, 2.5, or 3.0.

The yield ratio YR is defined by dividing the yield strength YS with the tensile strength TS.

The lower limit of YR may be 0.35, 0.36, 0.37, 0.38, 0.39, or 0.40.

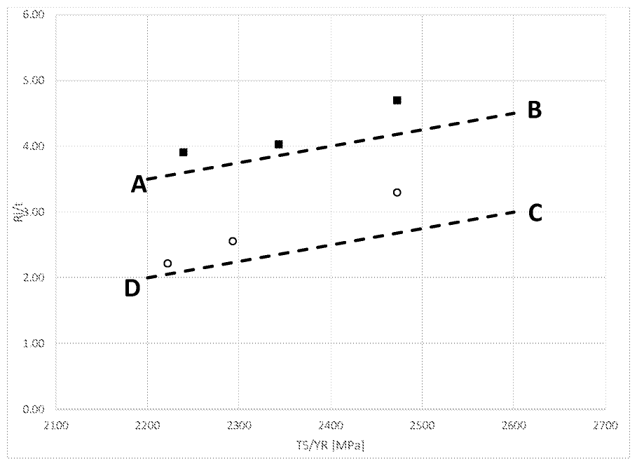

The steel should further be within the area defined by the coordinates A, B, C, D of FIG. 1, where Ri/t (y-axle) is plotted vs TS (MPa)/YR (x-axle), and where A is [2200, 3.5), B is [2600, 4.5], C is [2600, 3], and D is [2200, 2]. The upper dotted line can be mathematically expressed as y=0.0025*x−2 and the lower dotted line can be expressed as y=0.0025*x−3.5. This provides a criteria 2≤0.0025*TS/YR−Ri/t≤3.5. Steels fulfilling the criteria has been found out to have a good balance between strength and bendability. The lower limit may be 2.2, 2.4 or 2.6 and the upper limit may be 3.5, 3.3, or 3.1.

The TS/YR ratio can further be limited such that TS/YR is within 2200-2600 MPa. The lower limit may be 2200 or 2300. The upper limit may be 2600 or 2500. A preferred range can be 2400-2600.

The cold rolled heat treated steel sheet of the present invention may optionally be coated with zinc or zinc alloys, or with aluminum or aluminum alloys to improve its corrosion resistance.

The suggested steel can be produced by making steel slabs of the conventional metallurgy by converter melting and secondary metallurgy with the composition suggested above. The slabs are hot rolled in austenitic range to a hot rolled strip. Preferably by reheating the slab to a temperature between 1000° C. and 1280° C., rolling the slab completely in the austenitic range wherein the hot rolling finishing temperature is greater than or equal to 850° C. to obtain the hot rolled steel strip. Thereafter the hot rolled strip is coiled at a coiling temperature in the range of 500-540° C. Optionally subjecting the coiled strip to a scale removal process, such as pickling. The coiled strip is thereafter batch annealed at a temperature in the range of 500-650° C., preferably 550-650° C., for a duration of 5-30 h. Thereafter cold rolling the annealed steel strip with a reduction rate between 35 and 90%, preferably around 40-60% reduction. Further treating the cold rolled steel strip in a Continuously Annealing Line (CAL) or in a Hot Dip Galvanizing Line (HDGL), in which the microstructure is fine tuned. Both lines includes subjecting the steel to a soaking temperature of 800-1000° C., preferably 830-900° C., preferably followed by a slow jet and rapid jet cooling to a holding temperature of 350-450° C. for a time of 150 to 1000 s, before cooling to room temperature. The soaking time could e.g. be 40 s to 180 s.

In an embodiment steel the steel can be characterised by the following: A cold roll strip or sheet having a composition comprising of (in wt. %):

| | |
|---|---|
| C | 0.12-0.20 |
| Mn | 1.9-2.6 |
| Cr | 0.15-0.3 |
| Si | 0.3-0.8 |
| Al | 0.8-1.2 |
| Nb | ≤0.008 |
| Ti | ≤0.02 |
| Mo | ≤0.08 |
| Ca | ≤0.005 |
| V | ≤0.02 |

balance Fe apart from impurities; and
   fulfilling at least one of the following conditions:

| | | |
|---|---|---|
| TS tensile strength (Rₘ) | 950-1150 | MPa |
| YS yield strength (Rp_{0.2}) | 350-600 | MPa |
| YR yield ratio (Rp_{0.2}/Rₘ) | ≥0.38 | |
| bendability (Ri/t) | ≤4. | |

### EXAMPLE

Steel I1 and reference steel R1 were produced by conventional metallurgy by converter melting and secondary metallurgy. The compositions are shown in table 1, further elements were present only as impurities, and below the lowest levels specified in the present description. All steels having about the same composition.

TABLE 1

| Steel | C | N | Mn | Cr | Si | Al |
|---|---|---|---|---|---|---|
| I1 | 0.17 | 0.0033 | 2.33 | 0.23 | 0.464 | 0.96 |
| R1 | 0.17 | 0.0033 | 2.33 | 0.23 | 0.464 | 0.96 |

The steels were continuously cast and cut into slabs.

The slabs were reheated and hot rolled in austenitic range to a thickness of about 3.2 mm. The hot rolling finishing temperature was about 900° C.

The hot rolled steel strips where thereafter coiled, steel I1 at a coiling temperature of 530° C. and the reference steel R1 at about 630° C.

The coiled hot rolled strips were pickled and batch annealed at about 624° C. for 10 hours in order to reduce the tensile strength of the hot rolled strip and thereby reducing the cold rolling forces.

The strips were thereafter cold rolled in a five stand cold rolling mill to a final thickness of about 1.5 mm and finally conveyed to Hot Dip Galvanizing Line (HDGL). In the HDGL the strips were heated to a soaking temp of about 850° C. and held there for about 120 s. After annealing, the strips were slow jet cooled to about 750° C. (SJC), and then rapid jet cooled to a holding temperature of about 400° C. (RJC) and held at about 180 s. The strips where hot dip galvanised to apply a Zn coating.

The strip was soaked above A_{c3}=778° C. A_{c3} was determined by the formula:

$${A}_{c 3} = 910 - 203 * {C}^{1 / 2} - 15.2 Ni - 30 Mn + 44.7 Si + 104 V + 31.5 Mo + 13.1 W .$$

The process parameters are shown in table 2.

TABLE 2

| | | | | | | Hot Dip | | |
|---|---|---|---|---|---|---|---|---|
| | | | Batch | | | Galvanizing Line | | |
| | Hot rolling | | anneal | Cold rolling | | Soaking | | |
| | t | temp | B_temp | t | red | temp | SJC | RJC |
| Steel | (mm) | (° C.) | (° C.) | (mm) | (%) | (° C.) | (° C.) | (° C.) |
| I1 | 3.2 | 530 | 570 | 1.5 | 44 | 860 | 750 | 400 |
| R1 | 3.2 | 630 | 570 | 1.5 | 44 | 860 | 750 | 400 |

Yield strength YS and tensile strength TS were derived according to the European norm EN 10002 Part 1. The samples were taken in the longitudinal direction of the strip.

Samples of the produced strips were subjected to V bend test in accordance with JIS Z2248 to find out the limiting bending radius (Ri). The samples were examined both by eye and under optical microscope with 25 times magnification in order to investigate the occurrence of cracks. Ri/t was determined by dividing the limiting bending radius (Ri) with the thickness of the cold rolled strip t. Ri is the largest radius in which the material shows no cracks after three bending tests.

The limiting bending radius (Ri) of the steel I1 that was coiled at 530° C. was less than that R1 that was coiled at 630° C.

The mechanical properties are shown in table 3.

TABLE 3

| | | | YR | Unif. | Total El | | | |
|---|---|---|---|---|---|---|---|---|
| | YS | TS | R_{p0.2}/ | El | JIS | | | 0.0025*TS/ |
| Steel | R_{p0.2} | Rₘ | Rₘ | JIS | (A50) | Ri | Ri/t | YR - Ri/t |
| I1 | 399 | 989 | 0.40 | 12.3 | 16.1 | 5 | 3.3 | 2.88 |
| R1 | 401 | 990 | 0.41 | 12.3 | 16.2 | 7 | 4.7 | 1.34 |

The microstructure of I1 was determined to:

| | |
|---|---|
| Bainite + Tempered Martensite | about 45%, |
| Fresh martensite | about 20%, |
| retained austenite | about 10%, |
| polygonal ferrite | about 25%. |

In FIG. 1 the limiting bending radiuses (Ri) divided by thickness has been plotted against the tensile strengths divided by the yield ratios, TS/YR. The reference steel R1 that was coiled at a higher temperature was above the upper dotted line defined by:

$$Ri / t = 0.0025 * TS / YR - 2$$

The inventive steel I1 is below this line.

The lower dotted line is defined by

$$Ri / t = 0.0025 * TS / YR - 3.5$$

The inventive steel I1 is above this line. Within these borders a good bending property in relation to strength and toughness is achieved.

1. A cold rolled steel strip or sheet
a) having a composition consisting of (in wt. %):

| | |
|---|---|
| C | 0.08-0.28 |
| Mn | 1.5-4.5 |
| Cr | 0.01-0.5 |
| Si | 0.01-2.5 |
| Al | 0.5-2.0 |
| Mn + Cr | 1.8-5 |
| Nb | ≤0.1 |
| Ti | ≤0.1 |
| Mo | ≤0.5 |
| Ca | ≤0.05 |
| V | ≤0.1 |
| Cu | ≤0.06% |
| Ni | ≤0.08% |
| B | ≤0.0006% |
| P[[:]] | ≤0.02% |
| S | ≤0.005% |
| As | ≤0.010% |
| Zr | ≤0.006% |
| Sn | ≤0.015% |
| O | ≤0.0003 |
| H | ≤0.0020 |
| N | ≤0.015% |

balance Fe apart from impurities;
b) fulfilling the following conditions:

| | | |
|---|---|---|
| TS tensile strength (Rₘ) | 950-1350 | MPa |
| YS yield strength (Rp_{0.2}) | 350-1150 | MPa |
| YR yield ratio (Rp_{0.2}/Rₘ) | ≥0.35 | |
| bendability (Ri/t) | ≤4; | |

c) being within the area defined by the coordinates A, B, C, D, where Ri/t y-axle is plotted vs TS/YR x-axle, and where A is [2200, 3.5], B is [2600, 4.5], C is [2600, 3], and D is [2200, 2];
d) having a multiphase microstructure comprising in vol %

| | |
|---|---|
| tempered martensite + | ≥40 |
| bainite | |
| fresh martensite | 10-30 |
| retained austenite | 5-20 |
| polygonal ferrite | 10-35; |

e) wherein the amount of retained austenite was measured by means of the saturation magnetization method described in detail in Proc. Int. Conf. on TRIP-aided high strength ferrous alloys (2002), Ghent, Belgium, p. 61-64;
f) wherein the bendability Ri/t is determined in accordance with JIS Z2248 and where t is the sheet thickness; and
g) wherein the yield strength and tensile strength are determined according to the European norm EN 10002 Part 1.

2. The cold roll strip or sheet according to claim 1, wherein the composition comprising (in wt %):

| | |
|---|---|
| C | 0.12-0.20 |
| Mn | 1.9-2.6 |
| Cr | 0.15-0.3 |
| Si | 0.3-0.8 |
| Al | 0.8-1.2 |
| Nb | ≤0.008 |
| Ti | ≤0.02 |
| Mo | ≤0.08 |
| Ca | ≤0.005 |
| V | ≤0.02 |

balance Fe apart from impurities; and
b) fulfilling at least one of the following conditions:

| TS tensile strength (Rₘ) | 950-1150 MPa |
|---|---|
| YS yield strength (Rp_{0.2}) 3 | 50-600 MPa |
| YR yield ratio (Rp_{0.2}/Rₘ) | ≥0.38 |
| bendability (Ri/t) | ≤4. |

3. A method of manufacturing of a heat treated and cold rolled steel strip or sheet according to claim 1, comprising the following steps:
a) providing a steel slab;
b) hot rolling the slab in austenitic range to a hot rolled strip, wherein the hot rolling finishing temperature is greater than or equal to 850° C.;
c) coiling the hot rolled strip at a coiling temperature in the range of 500-540° C.;
d) optionally performing scale removal process on the coiled steel strip;
e) batch annealing the coiled strip at a temperature in the range of 500-650° C. for a duration of 5-30 h;
f) cold rolling the annealed steel strip with a reduction rate between 35 and 90%;
g) further treating the cold rolled steel strip in a Continuously Annealing Line or in a Hot Dip Galvanizing Line, in which the soaking temperature is 800-1000° C., and a holding temperature is 350-450° C. for a time of 150 to 1000 s; and
h) further cooling the steel strip down to room temperature.

4. The method according to claim 3, fulfilling at least one of the following conditions:
in step b) reheating the slab to a temperature between 1000° C. and 1280° C.;
in step f) batch annealing in the range of 550-650° C.;
in step g) a soaking temperature is 830-900° C.
